(19) United States
(12) Patent Application Publication
(10) Pub. No.: US 2001/0032807 A1
(43) Pub. Date: Oct. 25, 2001

(54) Fruit handling with color sorting

(76) Inventor: Harry C. Powell JR., Faber, VA (US)

Correspondence Address: NIXON & VANDERHYE P.C., 1100 North Glebe Rd., 8th Floor, Arlington, VA, 22201-4714, US

(21) Appl. No.: 09/774,677

(22) Filed: Feb. 1, 2001

Related U.S. Application Data
(60) Provisional application No. 60/185,501, filed on Feb. 28, 2000.

(51) Int. Cl. B07C 5/16

(52) U.S. Cl. 209/592; 209/587

(57) ABSTRACT

A method and apparatus handles discrete bruisable articles, such as apples or other pieces of fruit, with a minimum amount of bruising while determining a number of different properties of the articles, including optical properties. The articles are conveyed by conveyor cups over a load cell to determine their weight, and perhaps other properties, and then the cups are tilted so that the articles roll onto soft surface rollers with at least one back stop brush positioned where the rolling occurs. The rollers are rotated as the articles are conveyed by the rollers, so as to turn an article mounted between rollers so that a camera can evaluate optical properties of a large portion of each article, if not substantially all. Then a rotating brush disposed at an angle of between about 25-65 (e.g. about 45) degrees to the direction of roller movement moves the articles back to the cups, substantially without bruising, and eventually the cups are selectively tilted to sort the articles into a number of different categories dependent upon the weight and optical properties, and perhaps other properties, of the articles. The cups and rollers may have the same pitch, or different pitches, depending upon the articles being handled.

### CROSS-REFERENCE TO RELATED APPLICATION

This application is based upon provisional application Ser. No. 60/185,501 filed Feb. 28, 2000, the disclosure of which is hereby incorporated by reference herein.

### BACKGROUND AND SUMMARY OF THE INVENTION

As disclosed in U.S. Pat. Nos. 5,086,909 and 5,183,151, the disclosures of which are hereby incorporated by reference herein, it is highly desirable to handle bruisable articles, such as apples, peaches, or other pieces of fruit, and some vegetables, in a gentle manner so that rotten spots, discolorations, or other imperfections which can lower the market value, or quality, of the articles are avoided. However there are a number of circumstances, for particular types of articles, such as apples, where it is desirable to move the articles from one type of conveyor to another, since different types of conveyors are better suited to facilitating accurate determination of different properties (such as size, weight, color, etc.) of the articles being sorted. In many prior art constructions which, for example, do both weight sizing as well as color sorting (such as shown in U.S. Pat. Nos. 5,626,238, 5,751,833, and 5,878,863) there are a number of situations where fruit is shuttled from one conveyor to another where bruising can or does occur.

According to the present invention a method and apparatus are provided for handling discrete bruisable articles with a minimum amount of bruising, even though the articles may be transferred from one conveyor to another, and perhaps transfers may occur even multiple times. Not only do the method and apparatus according to the present invention handle articles with minimum bruising, they also have maximum versatility. For example according to the teachings of the invention it is possible to use conveyor elements between which the articles are transferred that do not have the same pitch (for example between four inch center cups and three inch center rollers, and vice versa), something not practical in the prior art, such as shown in U.S. Pat. No. 5,878,863 (the disclosure of which is hereby incorporated by reference herein). Also according to the method and apparatus of the present invention it is possible to easily retrofit already existing weight sizers, such as shown in U.S. Pat. Nos. 4,957,619, 5,044,504 (the disclosures of which are hereby incorporated by reference herein), and the earlier mentioned U.S. Pat. Nos. 5,183,151 and 5,086,909 patents, even if the user of the equipment does not have the approximately ten feet extra length space that is necessary to add optical sorting capabilities to existing weight sizers according to the invention. The optical equipment can be placed at an intermediate point in the weight sizer line so that transfer takes place from the weight sizer cups to rollers associated with the optical unit, and then back from the optical unit to the cups of the weight sizer for ultimate tilting of the cups to sort the articles, as is conventional. Also since there is no interference between the rollers and cups that are typically used as the conveying elements in the practice of the present invention, the system will never “crash”, resulting in significant machine breakage, as has occurred in the past with some commercial sorters which sort both on the basis of weight and optical properties.

According to the present invention there is provided a method of handling discrete bruisable articles using a first conveyor having first conveying elements, and a second conveyor having second conveying elements, comprising: (a) Providing a plurality of discrete bruisable articles on the first conveying elements. (b) Determining at least a first property of the articles while on the first conveying elements while conveying the articles in a first given direction. (c) Moving the articles off the first conveying elements onto the second conveying elements substantially without bruising the articles. (d) Determining at least a second property of the articles, different than the first property, while on the second conveying elements while conveying the articles in a second given direction. (e) Moving the articles off the second conveying elements back onto the first conveying elements substantially without bruising the articles. And, (f) after (e), moving the articles off the first conveying elements to sort the articles into at least two different categories in response to the first and second properties of the articles determined in the practice of (b) and (d). Typically, but not necessarily, (a) through (f) are practiced sequentially, although particularly (b) may be practiced after (e) and before (f), and other modifications are practical.

In the preferred embodiment the first and second directions are substantially parallel substantially linear directions, and at least one of (c) and (e) is practiced using a rotating brush disposed at an angle of between about 25-65 degrees with respect to the first and second directions. Also in the preferred embodiment the first conveying elements are tiltable conveying cups, and the second conveying elements are rollers; and (c) is practiced to tilt the cups so that the articles roll off the cups onto the rollers, and to prevent the articles from rolling off the rollers. Also (c) may be further practiced to prevent the articles from rolling off the rollers by providing a backstop brush adjacent the rollers and where the cups are titled.

Normally the main reason for providing rollers is to effect rotation of the articles as they are being conveyed so that their optical properties may be readily determined using a camera. That is typically there is the further procedure (g) of rotating the rollers about an axis substantially perpendicular to the second direction while conveying the articles in the second direction; and preferably (d) is practiced at least in part to determine optical properties of the articles (e.g. color, or size) using at least one camera. Usually (b) is practiced at least in part to determine the weight of the articles, and in the preferred embodiment (a)-(g) are practiced using pieces of fruit as the discrete bruisable articles.

By practicing the invention it is possible that the procedures set forth above may be practiced using cups having a different pitch than the rollers.

In order to facilitate transfer, according to the invention, the method may further comprise tilting the cups at an angle greater than zero (e.g. about 5-10 degrees) which angle is large enough to facilitate movement of articles from the rollers onto the cups but small enough to substantially prevent articles from rolling off the cups once moved onto the cups.

According to another aspect of the present invention there is provided a method of handling discrete bruisable articles using a first conveyor having first conveying elements, and a second conveyor having second conveying elements, and a rotatable brush, comprising: (a) Providing a plurality of discrete bruisable articles on the second conveying elements. (b) Determining at least one property of the articles while on the second conveying elements while conveying the articles in a given direction. (c) Moving the articles off the second conveying elements onto the first conveying elements substantially without bruising the articles by rotating the brush to engage the articles on the second conveying elements and move them to the first conveying elements. And, (d) sorting the articles into at least two different groups depending upon the property determined in (b). The details of the method may be as set forth above. For example the first conveying elements are tiltable conveying cups, and then (d) is practiced after (c) by tilting selected cups to cause the articles to roll off the cups into different groups; and the method preferably further comprises (e) rotating the rollers about an axis substantially perpendicular to the given direction while conveying the articles in the given direction, and then (b) is practiced at least in part to determine optical properties of the articles using at least one camera.

According to another aspect of the present invention there is provided an apparatus for sorting discrete bruisable articles, comprising: A first conveyor having first conveying elements. a second conveyor having second conveying elements. A first property determining device which determines at least a first property of the articles while on the first conveying elements being conveyed in a first given direction. A first mechanism which moves the articles off the first conveying elements onto the second conveying elements substantially without bruising the articles. A second property determining device which determines a second property of the articles, different than the first property, while on the second conveying elements while being conveyed in a second given direction. A second mechanism which moves the articles off the second conveying elements back onto the first conveying elements substantially without bruising the articles. And, a third mechanism which moves the articles off the first conveying elements to sort the articles into at least two different categories in response to the determined first and second properties of the articles.

In the preferred embodiment the first and second directions are substantially parallel, and at least one of the first and second mechanisms comprises a brush extending across the first and second conveying elements and disposed and rotatable at an angle of between about 25-65 degrees with respect to the first and second directions. The invention contemplates all narrower ranges within the broad ranges set forth herein; for example “between about 25-65 degrees” means 30-45 degrees, 35-60 degrees, 45-65 degrees, and all other narrower ranges within the broad range recited. Preferably the first conveying elements are tiltable conveying cups, and the second conveying elements are rollers, in which case the first mechanism comprises means for tilting the cups so that the articles roll off the cups onto the rollers. The invention preferably further comprises means for preventing the articles from rolling off the rollers, and the third mechanism comprises means for tilting the cups. When the cups and rollers have the same pitch (e.g. both are on four inch centers) the brush preferably has an angle of about 45 degrees with respect to the direction of movement of the articles, but when the pitch changes the angle changes; for example if the cups have four inch centers and the rollers three inch centers, a brush angle of about 55 degrees, instead of 45 degrees, is desirable.

In order to facilitate general handling of the fruit, preferably the cups are soft cups such as described in U.S. Pat. No. 5,086,909. Also preferably the rollers are either of soft material such as EVA or urethane, or are covered by a soft material, to minimize bruising even more. Where desired a straight brush may be provided over the cups so that when the articles are conveyed from the rollers to the cups the articles will be stabilized on the cups.

The means for preventing the articles from rolling off the rollers may comprise a backstop brush adjacent at least one of the rollers and where the cups are titled. The apparatus also preferably further comprises means for rotating the rollers about an axis substantially perpendicular to the second direction while conveying the articles in the second direction, the roller rotating means preferably comprising a substantially stationary linear gear rack and a gear cooperating with the gear rack on each of at least some of the rollers. The second property determining means preferably comprises means for determining the optical properties of the articles, including at least one camera. While the cups preferably have the same pitch as the rollers, they may have different pitches and the apparatus may still function, with only minor adjustments of various components, such as the angle at which the rotating brush is disposed with respect to the direction of transport of the articles.

According to another aspect of the present invention there is provided an apparatus for sorting discrete bruisable articles, comprising: A first conveyor having first conveying elements and which conveys articles in a first direction. A second conveyor having second conveying elements and which conveys articles in a second direction substantially parallel to the first direction. A property determining device which determines at least a first property of the articles while on the second conveying elements being conveyed in the second direction. And, a brush extending across the first and second conveying elements and disposed and rotatable at an angle of between about 25-65 degrees with respect to the first and second directions and positioned to engage articles on the first conveying elements and move the articles onto the second conveying elements. The details of the apparatus are preferably as described above. Where the cups are tilted as the rotating brush is moving the articles back onto the cups, preferably a second brush is provided over the cups to facilitate holding articles in the cups when moved therein by the rotating brush. The second brush may also be powered so that it rotates about a substantially horizontal axis substantially perpendicular to the first direction with the tangential velocity of a bottom of the second brush substantially in the first direction.

It is the primary object of the present invention to provide a simple, cost effective and otherwise advantageous method and apparatus for determining a variety of different properties of bruisable articles, such as pieces of fruit, while gently handling the articles so as to minimize bruising. This and other objects of the invention will become clear from an inspection of the detailed description of the invention and from the appended claims.

### BRIEF DESCRIPTION OF THE DRAWINGS

FIG. 1 is a top schematic view of an exemplary retrofit of apparatus according to the invention, for practicing the method according to the present invention;

FIG. 2 is an end view of a multi-lane sizer according to the present invention showing the inter-relationship between the cup and roller conveying portions thereof;

FIG. 3 is a top plan view of one row of rollers of the sizer of FIG. 2 shown in juxtaposition with the apparatus frame;

FIG. 4 is a side view of the conveying mechanism for the rollers according to the invention, where the rollers interface with the cups;

FIG. 5 is an end view of one of the rollers of the apparatus of FIGS. 1 through 4 showing the mechanism for rotation of the roller, and with portions of the roller cut away to illustrate the internal portions thereof;

FIG. 6 is a top plan detail schematic view showing the transfer of apples (shown in dotted line) between the rollers and the cups in a preferred form of the apparatus of FIGS. 1 through 5;

FIG. 7 is a view like that of FIG. 6 only showing a modified form of brushes according to the present invention; and

FIG. 8 is a side partial schematic view of the embodiment of FIG. 7.

### DETAILED DESCRIPTION OF THE DRAWINGS

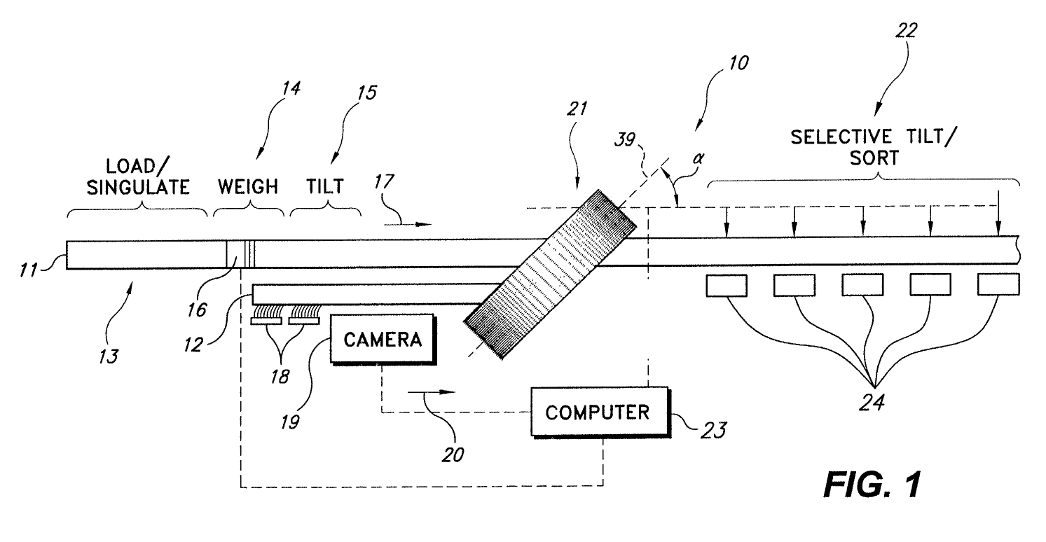

FIG. 1 schematically illustrates one form of exemplary apparatus according to the present invention for practicing the method of the present invention. The apparatus of FIG. 1 is most often used in a situation where there is an existing weight sizer and the owner merely wishes to add optical characteristics determining functionality to the unit, but has insufficient length in his or her facility to simply add the optical unit to the beginning of the existing sizer.

The apparatus shown generally by reference numeral 10 in FIG. 1 includes a first conveyor 11, having first conveying elements (preferably conventional cups such as shown in U.S. Pat. No. 5,086,909), and a second conveyor 12 which includes second conveying elements, preferably rollers, such as the rollers disclosed in U.S. Pat. No. 5,878,863, but preferably the rollers according to the invention as will be hereinafter described.

For the apparatus 10, the first conveyor 11 includes a loading/singulating station 13, a weigh-station 14 including a conventional load cell 16 or the like, and a tilt station 15 where the cups are tilted in a conventional manner, as shown in U.S. Pat. No. 5,086,909, to cause the articles therein (such as apples or other pieces of fruit, or vegetables) to move onto the rollers of the second conveyor 12. A back stop mechanism may be associated with the second conveyor 12 at the tilting area 15, such as the substantially stationary back stop brushes 18. The conveyor 11 moves the articles in the first direction 17.

The second conveyor 12 has an optical properties determining apparatus or system associated therewith, including at least one camera 19. The articles are transported in a second direction 20 by the conveyor 12 while the articles are being rotated by the rollers. The second direction 20 preferably is parallel to the first direction 17 in the preferred embodiment. The camera 19 may be a conventional camera, or a plurality of cameras, such as shown in U.S. Pat. No. 5,878,863, or may be the simplified but greater functionality camera system as described hereafter.

After the optical properties of the articles are determined by the camera 19, etc., a mechanism—preferably in the form of a rotating brush 21—is provided for moving the articles from the conveyor 12 back onto the first conveyor 11. The rotating brush 21 will be described hereafter. Once the articles get back on the first conveyor 11, they move to the sorting section 22 where the cups of the first conveyor 11 are selectively tilted—depending upon signals from control computer 23 provided with data from the load cell 16 and the camera 19—to sort the articles into at least two different categories, preferably the bins or other areas 24.

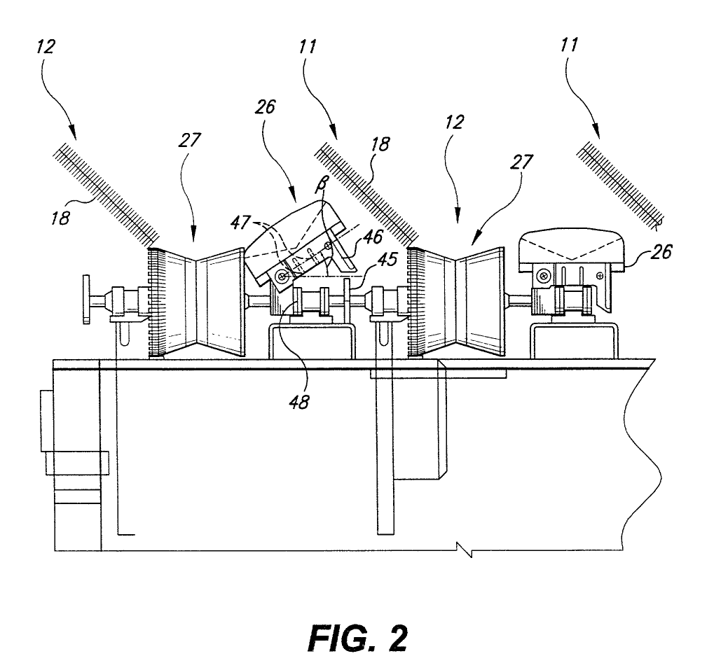

FIG. 2 shows the interface between the first and second conveyors 11,12. While, for simplicity, FIG. 1 illustrates a single lane system 10, most commercial installations will be at least two lanes wide, typically six to ten lanes wide. As seen in FIG. 2, the first conveyor 1 in this preferred embodiment has conventional cups 26 which are tiltable, and the cups preferably are also of soft material. The details of the cups 26, their mechanism for transport, how they are tilted, and what they are made of, is preferably as described in U.S. Pat. No. 5,086,909.

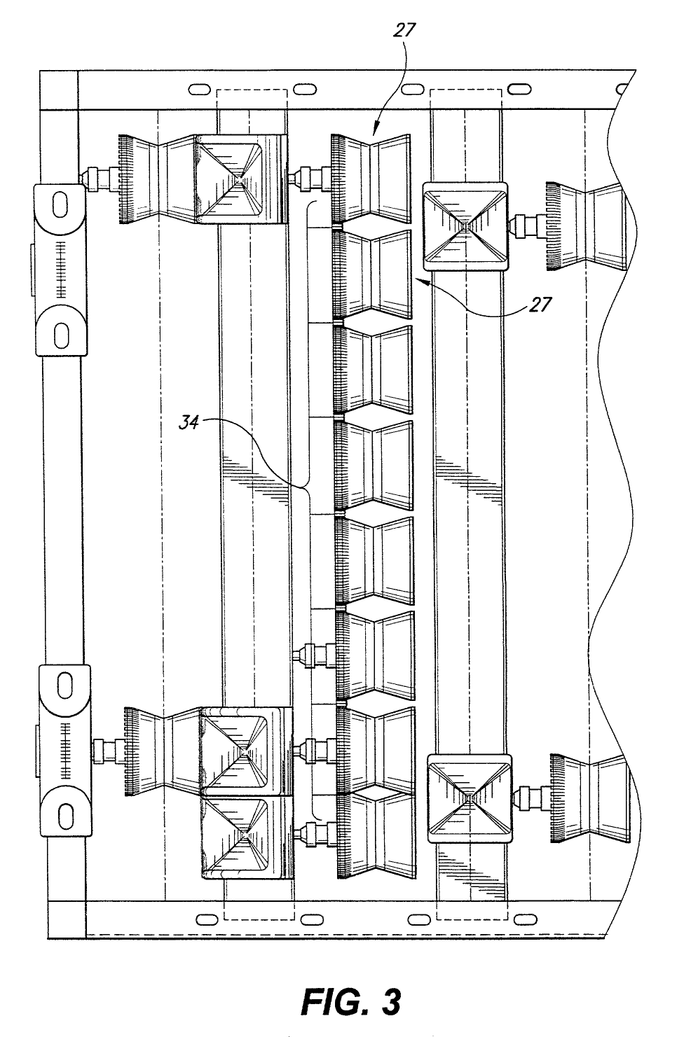

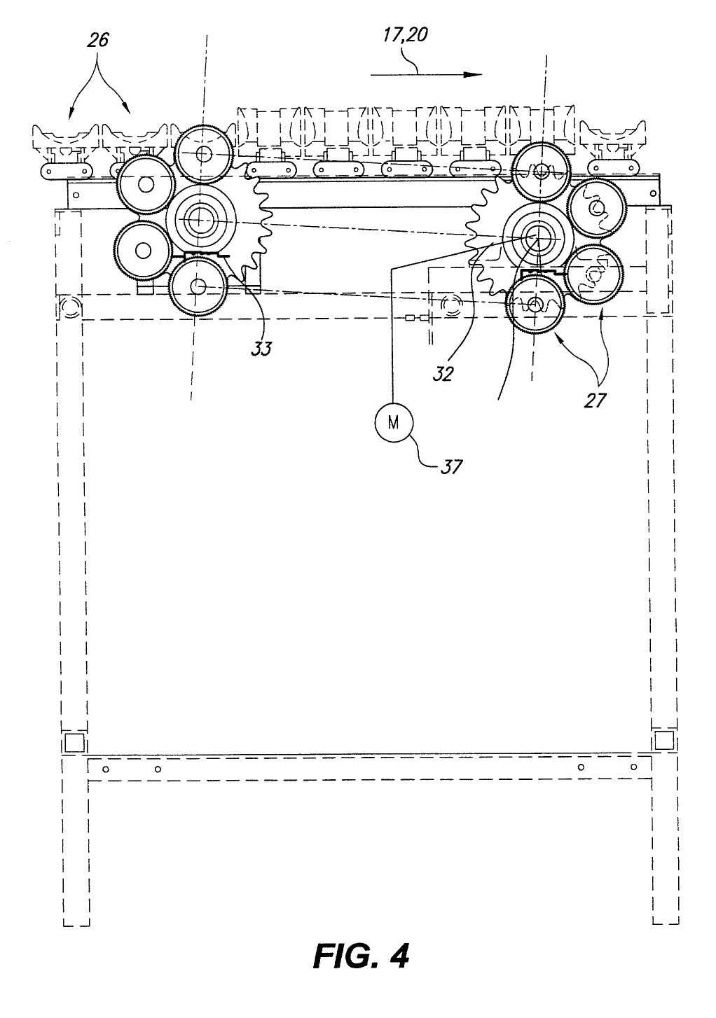

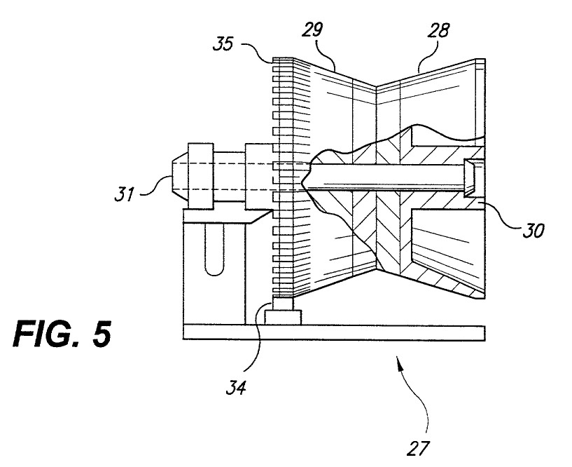

The rollers for the second conveyor 12 are illustrated generally by reference numeral 27 in FIGS. 2 through 5. While the rollers 27 may have other configurations, such as shown in U.S. Pat. No. 5,878,863, preferably they comprise two frusto-conical components (see FIG. 5) 28, 29, rotatable about a shaft 30, with the shaft 30 mounted in a chain 31 which is engaged by the sprockets 32, 33 (see FIG. 4). The sprockets 32, 33 are powered by a motor 37, which may be controlled by the computer 23.

The rollers 27 preferably are rotated while they move in direction 17, 20. While this may be accomplished by any suitable conventional technique, preferably there is a linear gear rack 34 extending along the frame conveyor 12 which is engaged by a gear 35 mounted to the roller 27. As the chain 31 moves in the direction 20 the gears 35 engage the rack 34, rotating the rollers 27. While a gear 35 may not be provided for each roller 27, preferably each roller 27 does have a gear 35 associated therewith.

In order to minimize bruising, preferably the body of each roller 27 is composed of or covered by a soft resilient material, such as EVA or urethane. The rollers 27 rotate so as to turn an article A mounted thereby so that the camera 19 can evaluate optical properties of a large portion (if not all) of the articles A.

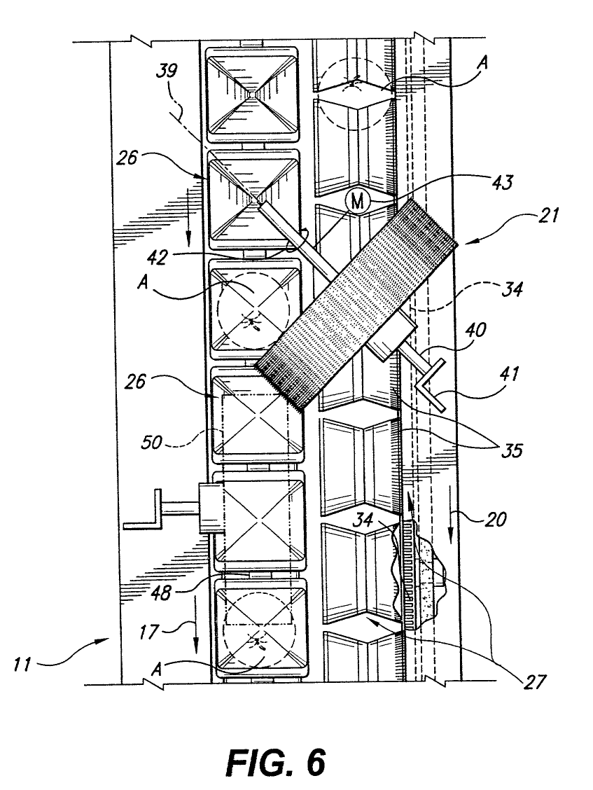

After the camera 19 determines the suitable optical properties of an apple (shown in dotted line at A in FIG. 6), or other article, the apple A is moved back to the first conveyor 11 utilizing the brush 21. The brush 21 preferably comprises a long bristle brush that is rotatable about an axis 39 preferably defined by a shaft 40 mounted by bearings 41 (see FIG. 6). The shaft 40 may be rotated in the direction 42 indicated in FIG. 6 by any suitable powered device, such as the electric motor illustrated schematically at 43 in FIG. 6. The motor 43 also may be controlled by the computer 23. The axis 39 of the brush 21 makes an angle α (see FIG. 1) with the direction 17, 20. The angle α preferably is between about 25-65 degrees, or any other narrower range within that broad range, preferably about 45 degrees when the cups 26 and the rollers 27 have the same pitch. However when the pitches of the cups 26 and rollers 27 are different then the angle α can be changed. For example if the angle α is about 45 degrees when the cups 26 and rollers 27 are on four inch centers, if the rollers 27 are changed to three inch centers while the cups 26 are still on four inch centers, then the angle α could be changed to about 55 degrees.

The motor 43 rotates the brush 21 at a relatively slow speed, but one that is fast enough so that the apples A are gently moved from the rollers 27 to a cup 26. While not entirely necessary, it is desirable that the cups 26 be tilted slightly toward the rollers 27 at the area where the brush 21 moves the apples A onto the cups 26. This is accomplished by providing a ramp 45 which engages a linear cam 46 on the bottom of a cup 26 so that the cup 26 pivots about a pivot pin 47 as it is being moved in the direction 17 by the chain 48 (see FIG. 2). The height of the ramp 45 is such that the tilt angle β is greater than zero and large enough to facilitate movement of apples A from the rollers 27 onto the cups 26, but small enough to substantially prevent articles from rolling off the cups 26 once moved onto them. For example the angle β is preferably between about 5-10 degrees, which is less than the tilt angle in the sections 15, 22, which typically is about 25 degrees or more.

Where desirable for particular types of articles, in order to facilitate holding the articles, such as apples A, on the cups 26 when first moved thereon by the brush 21, before the cups 26 no longer engage an elevated ramp 45 so that they become flat again (after the brush 21 in FIGS. 1 and 6), a second rotating or stationary brush, shown in dotted line at 50 in FIG. 6, may be provided. Preferably the brush 50 rotates about a substantially horizontal axis substantially perpendicular to the direction 17, and in a direction so that the tangential velocity of the bottom of brush 50 is substantially in the direction 17. An apple A moving onto the cup 26 engages the brush 50 and deflects the bristles of the brush 50, which cushion and facilitate the movement of the apple A onto the cup 26, and also arrest the momentum of the apple A moving away from the conveyor 12. At the point where the brush 21 moves the apples onto the cups 26, the bristles of the brush 21 will cover the gear 35 and rack 34 so that they do not harm the apple A.

While the gear 35 and rack 34 are shown positioned at one of the rollers 27 in FIG. 6 it is to be understood that they could be at the opposite end under appropriate circumstances.

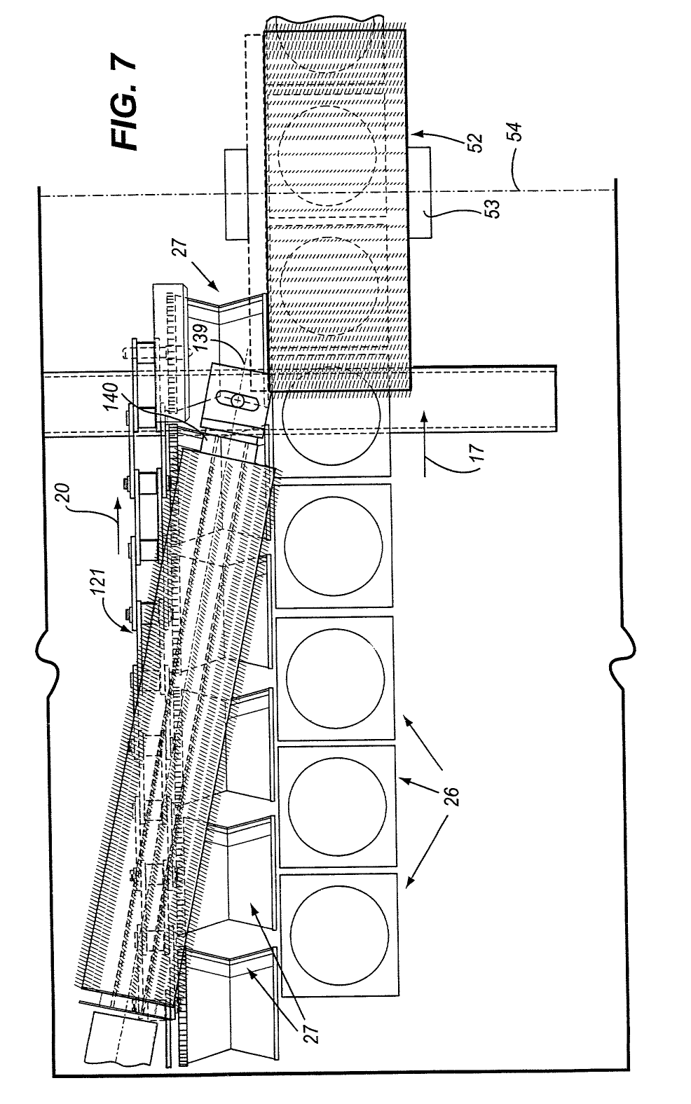

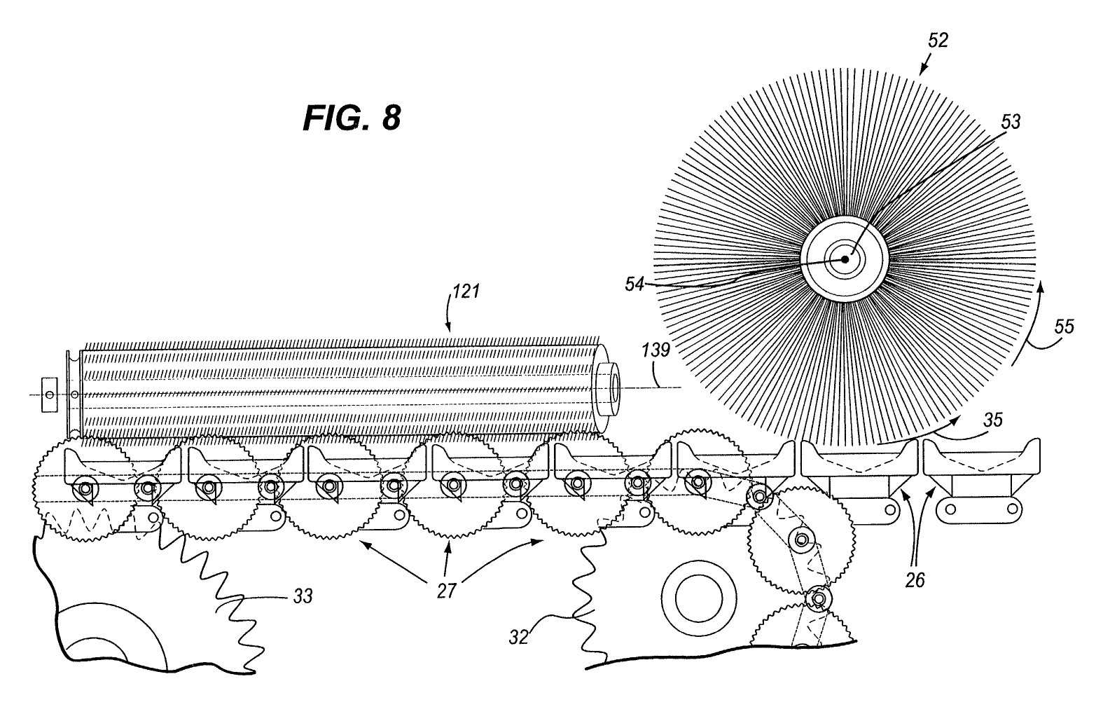

The embodiment of FIGS. 7 and 8 is similar to that of FIGS. 4 and 6, and components that are substantially identical are shown by the same reference numerals, while modified components are shown by the same reference numeral only preceded by a “1”.

One of the major differences of the FIGS. 7 and 8 embodiment is that in the FIGS. 7 and 8 embodiment the long bristle brush 121 is elongated [for example it preferably has a length at least as long as the lengths of three of the cups 26] compared to the brush 21, and when rotating about the axis 139, mounted by the shaft 140, provides a more gradual transition of fruit from the rollers 27 to the cups 26. This is particularly desirable for lumpy fruit, such as pears. The elongated and smaller diameter (than brush 21) brush 121 is also particularly desirable when the pitch of the cups 26 and rollers 27 is substantially identical.

Also the FIGS. 7 and 8 embodiment shows a second brush 52 mounted by a shaft 53 for rotation about an axis 54 substantially perpendicular to the direction 17. The brush 54, which preferably has long bristles, rotates in the direction 55 illustrated in FIG. 8, and is disposed substantially above the cups 26, preferably just past the brush 121, and where the rollers 27 are moving downwardly at the gear 32. The purpose of the brush 52 is to help settle the fruit in the cups 26, which again is particularly desirable with lumpy fruit. Preferably the brush 52 has a diameter significantly larger than (e.g. about three to five times) that of the brush 121. Preferably the bristles of the brush 52 do not actually touch the cups 26, but are just above the cups 26 at some points, as illustrated in FIG. 8.

While the relative positions between the conveyors 11, 12 illustrated in FIG. 1 is preferred for many retrofits, for new installations or for some retrofits the second conveyor 12 can be before the first conveyor 11 and loading and singulating can take place on the first conveyor 12 using conventional loading and singulating equipment.

In a method of operation of the apparatus 10, a plurality of discrete bruisable articles A are provided on the first conveying elements (such as cups 26) on the first conveyor 11. A first property of those articles (such as the weight thereof, although alternative or additional properties may also be determined) are determined while the articles A are on the first conveying elements 26 while being conveyed in the first direction 17. Then the articles are moved off the first conveying elements 26 onto the second conveying elements (such as the rollers 27) of the second conveyor 12 substantially without bruising the articles. This is accomplished in the preferred embodiment illustrated by tilting the cups 26 using the ramp 45 so that the articles A roll off the cups 26 onto the rollers 27. The back stop brushes 18 prevent the articles A from rolling too far, and since the cups 26 are immediately adjacent the rollers 27 there is little probability that the articles will be bruised. Also by making the cups 26 and the rollers 27 of, or covered by, a soft material such as EVA or urethane, bruising is minimized further.

Next according to the method at least a second property (such as the optical properties like color and reflectance, although other properties may additionally or alternatively be determined, such as the shape, approximate diameter, or other physical size characteristic, or the like) is determined while on the second conveying elements 27 while conveying the articles in a second direction 20, which preferably, although not necessarily, is the same as, the first direction 17. Then the articles A are moved off the second conveying elements 27 back onto the first conveying elements 26 by moving the articles A by the conveyor 12 into operative contact with the rotating brush 21 which moves the articles A off of the rollers 27 onto a cup 26 that is preferably slightly tilted toward the rollers 27, with the articles A engaging the brush 50 as they are moved onto the cups 26. The cups 26, after returning to a substantially horizontal position, are conveyed to the sorting station 22, where under the control of the computer 23 ramps are selectively moved up into, or out of, the paths of the cams 46 of the cups 26 to selectively cause the cups 26 to tilt and to dump the apples A thereon into the appropriate sorting bin 24 depending upon the properties sensed by the load cell 16, camera 19, or any other property determining equipment. For example all high color apples having a weight over seven ounces go into the first bin 24, all poor color apples having a weight under four ounces go into the second bin 24, etc.

While the invention has been herein shown and described in what is presently conceived to be the most practical and preferred embodiment thereof it will be apparent to those of ordinary skill in the art that many modifications may be made thereof. For example the means for rotating the rollers 27, instead of providing the gears 35 and gear rack 34, may comprise any conventional roller rotating device for a similar purpose, such as shown in U.S. Pat. No. 5,878,863. Also the means for preventing the articles from rolling off the rollers 27 at the tilt station 15 may comprise a cushioned substantially stationary roller, back stop of a flat piece of foam, or any other conventional device, instead of or in addition to the back stop brush or brushes 18. Also the property determining means may be any other suitable conventional article property determining devices instead of or in addition to the load cell 16 and the camera 19.

While a conventional camera arrangement for fruit or vegetable sorting, or the like, may be utilized as the camera 19, a simplified yet advanced camera system may be provided, for example so that one camera 19 can both optically size and color determine the pieces of fruit A. A single snapshot camera, or a camera operated in a snap mode, which changes gain and/or exposure on the fly may be utilized. For example the camera (19) is adjusted for high gain when taking a first snapshot, so that the edges of the fruit A are very pronounced for easy dimensioning, but then the next (or other subsequent) snapshot is taken at a low gain for high color resolution. A computer (23) automatically changes the gain between low and high positions that are optimal for this purpose (which will depend upon the type of camera used). While the exposure time may be varied instead of or in addition to gain, if the articles A are being moved quickly by the conveyor 12 then gain, and gain alone, is the best parameter. However where the objects are moving relatively slowly then exposure time, in addition to or in place gain can, be a useful tool.

Typically the time between snapshots of the camera (19) as controlled by a computer (23) is about 30 milliseconds, so that two snapshots are taken in 60 milliseconds, one better suited for dimensioning, and the other better suited for color resolution, both outputs being sent to the computer 23.

While a wide variety of cameras may be utilized according to this aspect as described above, one commercially available camera that is suited for this purpose is a “DEPICT” IT, I, RT, HS, or Cl series camera from Opteon Corporation of Cambridge, Mass.

Thus it will be seen that according to the present invention a method and apparatus are shown for handling discrete bruisable articles in a gentle manner while effecting sorting thereof based upon two or more different properties, preferably at least weight and color or size. The method and apparatus handle the discrete articles in such a manner that bruising is minimized if not substantially eliminated, with simple and cost effective equipment, and in such a way that the conveying elements, such as cups, of one conveyor and the conveying elements, such as the rollers, of another conveyor may have different pitches. Also since the conveyor elements are separate from each other there cannot be interference between them which could cause the crashing or destruction of the entire apparatus. The invention is to be interpreted with the broadest scope of the appended claims so as to encompass all equivalent structures and methods.

What is claimed is:

1. A method of handling discrete bruisable articles using a first conveyor having first conveying elements, and a second conveyor having second conveying elements, comprising:
(a) providing a plurality of discrete bruisable articles on the first conveying elements;
(b) determining at least a first property of the articles while on the first conveying elements while conveying the articles in a first given direction;
(c) moving the articles off the first conveying elements onto the second conveying elements substantially without bruising the articles;
(d) determining at least a second property of the articles, different than the first property, while on the second conveying elements while conveying the articles in a second given direction;
(e) moving the articles off the second conveying elements back onto the first conveying elements substantially without bruising the articles; and
(f) after (e), moving the articles off the first conveying elements to sort the articles into at least two different categories in response to the first and second properties of the articles determined in the practice of (b) and (d).

2. A method as recited in claim 1 wherein (a)-(f) are practiced sequentially.

3. A method as recited in claim 1 wherein the first and second directions are substantially parallel linear substantially directions, and wherein at least one of (c) and (e) is practiced using a rotating brush disposed at an angle of between about 25-65 degrees with respect to the first and second directions.

4. A method as recited in claim 3 wherein the first conveying elements are tiltable conveying cups, and wherein the second conveying elements are rollers; and wherein (c) is practiced to tilt the cups so that the articles roll off the cups onto the rollers, and to prevent the articles from rolling off the rollers.

5. A method as recited in claim 4 wherein (c) is further practiced to prevent the articles from rolling off the rollers by providing a backstop brush adjacent the rollers and where the cups are titled.

6. A method as recited in claim 4 further comprising (g) rotating the rollers about an axis substantially perpendicular to said second direction while conveying the articles in the second direction.

7. A method as recited in claim 6 wherein (d) is practiced at least in part to determine optical properties of the articles using at least one camera.

8. A method as recited in claim 7 wherein (b) is practiced at least in part to determine the weight of the articles.

9. A method as recited in claim 8 wherein (a)-(g) are practiced using pieces of fruit as the discrete bruisable articles.

10. A method as recited in claim 4 wherein (a)-(f) are practiced using cups having a different pitch than the rollers.

11. A method as recited in claim 9 wherein (a)-(f) are practiced using cups having a different pitch than the rollers.

12. A method as recited in claim 4 further comprising tilting the cups at an angle greater than zero which angle is large enough to facilitate movement of articles from the rollers onto the cups but small enough to substantially prevent articles from rolling off the cups once moved onto the cups.

13. A method of handling discrete bruisable articles using a first conveyor having first conveying elements, and a second conveyor having second conveying elements, and a rotatable brush, comprising:
(a) providing a plurality of discrete bruisable articles on the second conveying elements;
(b) determining at least one property of the articles while on the second conveying elements while conveying the articles in a given direction;
(c) moving the articles off the second conveying elements onto the first conveying elements substantially without bruising the articles by rotating the brush to engage the articles on the second conveying elements and move them to the first conveying elements; and
(d) sorting the articles into at least two different groups depending upon the property determined in (b).

14. A method as recited in claim 13 wherein the first conveying elements are tiltable conveying cups, and wherein (d) is practiced after (c) by tilting selected cups to cause the articles to roll off the cups into different groups.

15. A method as recited in claim 14 wherein the second conveying elements are rollers, and further comprising (e) rotating the rollers about an axis substantially perpendicular to said given direction while conveying the articles in said given direction; and wherein (b) is practiced at least in part to determine optical properties of the articles using at least one camera.

16. A method as recited in claim 15 wherein (a)-(e) are practiced using pieces of fruit as the discrete bruisable articles.

17. Apparatus for sorting discrete bruisable articles, comprising:
a first conveyor having first conveying elements;
a second conveyor having second conveying elements,
a first property determining device which determines at least a first property of the articles while on the first conveying elements being conveyed in a first given direction;
a first mechanism which moves the articles off the first conveying elements onto the second conveying elements substantially without bruising the articles;
a second property determining device which determines a second property of the articles, different than the first property, while on the second conveying elements while being conveyed in a second given direction;
a second mechanism which moves the articles off the second conveying elements back onto the first conveying elements substantially without bruising the articles; and
a third mechanism which moves the articles off the first conveying elements to sort the articles into at least two different categories in response to the determined first and second properties of the articles.

18. Apparatus as recited in claim 17 wherein said first and second directions are substantially parallel, and wherein at least one of said first and second mechanisms comprises a brush extending across said first and second conveying elements and disposed and rotatable at an angle of between about 25-65 degrees with respect to the first and second directions.

19. Apparatus as recited in claim 17 wherein said first conveying elements are tiltable conveying cups, and wherein said second conveying elements are rollers; and wherein said first mechanism comprises means for tilting said cups so that the articles roll off said cups onto said rollers; and further comprising means for preventing the articles from rolling off said rollers, and wherein said third mechanism comprises means for tilting said cups.

20. Apparatus as recited in claim 19 wherein said means for preventing the articles from rolling off said rollers comprises a backstop brush adjacent at least one of said rollers and where said cups are titled.

21. Apparatus as recited in claim 19 further comprising means for rotating said rollers about an axis substantially perpendicular to said second direction while conveying the articles in the second direction.

22. Apparatus as recited in claim 21 wherein said roller rotating means comprises a substantially stationary linear gear rack, and a gear cooperating with said gear rack on each of at least some of said rollers.

23. Apparatus as recited in claim 23 wherein said second property determining means comprises means for determining optical properties of the articles including at least one camera.

24. Apparatus as recited in claim 21 wherein said cups have a different pitch than said rollers.

25. Apparatus for sorting discrete bruisable articles, comprising:
a first conveyor having first conveying elements and which conveys articles in a first direction;
a second conveyor having second conveying elements and which conveys articles in a second direction substantially parallel to said first direction
a property determining device which determines at least a first property of the articles while on the second conveying elements being conveyed in said second direction; and
a brush extending across said first and second conveying elements and disposed and rotatable at an angle of between about 25-65 degrees with respect to said first and second directions and positioned to engage articles on said first conveying elements and move the articles onto said second conveying elements.

26. Apparatus as recited in claim 25 wherein the first conveying elements are rollers, and wherein the second conveying elements are tiltable conveying cups; and further comprising means for rotating said rollers about an axis substantially perpendicular to said first direction while conveying the articles in the first direction.

27. Apparatus as recited in claim 26 wherein said roller rotating means comprises a substantially stationary linear gear rack, and a gear cooperating with said gear rack on each of at least some of said rollers.

28. Apparatus as recited in claim 27 wherein said property determining means comprises means for determining optical properties of the articles including at least one camera.

29. Apparatus as recited in claim 25 wherein said cups have a different pitch than said rollers.

30. Apparatus as recited in claim 25 wherein said rollers have article-engaging surfaces of soft material which minimizes bruising of the articles engaged thereby.

31. Apparatus as recited in claim 30 wherein said rollers comprise, or are covered by, EVA or urethane.

32. Apparatus as recited in claim 25 further comprising a second brush over said cups to facilitate holding articles in said cups when slightly tilted and articles are moved therein by said rotating brush, said second brush rotating about a substantially horizontal axis substantially perpendicular to said first direction with the tangential velocity of a bottom of said second brush substantially in said first direction.

33. Apparatus as recited in claim 25 wherein said brush is elongated, having a length at least as long as the lengths of three cups, and gradually transitions discrete bruisable articles from said rollers to said cups.
